(19) United States
(12) Patent Application Publication
(10) Pub. No.: US 2026/0110328 A1
(43) Pub. Date: Apr. 23, 2026

(54) SHAFT ALIGNMENT COMPONENT AND METHODS OF ALIGNING SHAFT ASSEMBLIES

(71) Applicant: Steering Solutions IP Holding Corporation, Saginaw, MI (US)

(72) Inventors: Kyle R. Mazure, Saginaw, MI (US); Benjamin J. Kolhagen, Frankenmuth, MI (US); Bryce T. Silvernail, Kawkawlin, MI (US); Marcus Braem, Birch Run, MI (US)

(21) Appl. No.: 18/918,449

(22) Filed: Oct. 17, 2024

(51) Int. Cl. F16C 3/03; B62D 1/183

(52) U.S. Cl. CPC F16C 3/03; B62D 1/183; F16C 2226/00

(57) ABSTRACT

A shaft assembly includes at least a first shaft section having a first shaft body defining a cavity and a first aperture extending through the first shaft body, and at least a second shaft section having a second shaft body and a second aperture extending through the second shaft body. The second shaft section is received within the cavity of the first shaft body, such that the second shaft body axially translates within the cavity relative to the first shaft section. An alignment component is formed in the at least first shaft section, the alignment component being a non-punctured alignment component. The second shaft body contacts the alignment component when the first aperture of the first shaft body is aligned with the second aperture of the second shaft body.

### FIELD OF THE INVENTION

The embodiments described herein relate to vehicle steering systems and, more specifically, to shaft alignment components for aligning shafts of steering columns during assembly.

### BACKGROUND

Shaft assemblies are standard components in many mechanical systems, particularly in the automotive industry. These assemblies typically consist of two or more shaft sections that may be connected via torque-transferring geometries (e.g., splines) and fastened together with bolts and nuts. However, typical shaft assemblies struggle to ensure precise axial alignment between shaft geometries and their corresponding bolt through holes. Furthermore, visual alignment of the shaft geometries and their corresponding bolt through holes may be difficult, as visibility of the shaft assembly may be limited when the shaft sections are installed within a vehicle. One example of a shaft alignment feature includes a portion of the outer shaft which protrudes radially inwardly to function as a stop feature when inserting an inner shaft. However, this requires puncturing of the outer shaft to move the stop feature inwardly. This introduces the possibility of fluid intrusion and involves a complicated manufacturing process.

Accordingly, a need exists for a shaft assembly that includes an alignment component configured to ensure appropriate axial alignment of various shaft sections during assembly.

### SUMMARY OF THE INVENTION

In the embodiments described herein, a shaft assembly is disclosed. T shaft assembly includes at least a first shaft section having a first shaft body defining a cavity and a first aperture extending through the first shaft body, and at least a second shaft section having a second shaft body and a second aperture extending through the second shaft body. The second shaft section is received within the cavity of the first shaft body, such that the second shaft body axially translates within the cavity relative to the first shaft section. An alignment component is formed in the at least first shaft section, the alignment component being a non-punctured alignment component. The second shaft body contacts the alignment component when the first aperture of the first shaft body is aligned with the second aperture of the second shaft body.

In another embodiment, a steering column assembly is disclosed. The steering column assembly includes at least a first steering column section having a first column body defining a cavity, and at least a second steering column section having a second column body, the second steering column section being configured to be received within the cavity of the first column body of the first steering column section. A stopper formed in the at least first steering column section, the stopper being a non-punctured stopper that does not form an opening in the at least first steering column section. The steering column assembly is translatable between an extended position and a collapsed position in which the second column body contacts the stopper formed in the first column body

In yet another embodiment still, a method of aligning a shaft assembly is disclosed. The method involves forming a non-punctured protrusion extending into a cavity defined by a first shaft section of the shaft assembly; inserting a second shaft section into the first shaft section; translating the second shaft section within the first shaft section in an axial direction; and contacting the second shaft section with the non-punctured protrusion, such that a first aperture extending through the first shaft section aligns within a second aperture extending through the first shaft section.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a cross-sectional view of a shaft assembly including an alignment component formed in a shaft section, according to one or more embodiments shown and described herein;

FIG. 2A is a cross-sectional view of the shaft assembly of FIG. 1 in an unaligned position, according to one or more embodiments shown and described herein;

FIG. 2B is a cross-sectional view of the shaft assembly of FIG. 1 in an intermediate position, according to one or more embodiments shown and described herein;

FIG. 2C is a cross-sectional view of the shaft assembly of FIG. 1 in an aligned position, according to one or more embodiments shown and described herein;

FIG. 3 is a front view of an illustrative process of forming an alignment component in the shaft assembly of FIG. 1;

FIG. 4A is a cross-sectional view of a steering column assembly in a first position, according to one or more embodiments shown and described herein;

FIG. 4B is a cross-sectional view of the steering column assembly of FIG. 4A in a second position, according to one or more embodiment shown and described herein;

FIG. 5 is an illustrative flow diagram of a method of aligning a shaft assembly, according to one or more embodiments shown and described herein; and

FIG. 6 is an illustrative flow diagram of a method of limiting motion of a steering column assembly, according to one or more embodiments shown and described herein.

### DETAILED DESCRIPTION

Embodiments disclosed herein relate to shaft assemblies, alignment components for shaft assemblies, and methods of aligning shaft assemblies. The shaft assembly includes at least a first shaft section having a first shaft body defining a cavity and a first aperture extending through the first shaft body, and at least a second shaft section having a second shaft body and a second aperture extending through the second shaft body. The second shaft section is configured to be received within the cavity of the first shaft body, such that the second shaft body axially translates within the cavity relative to the first shaft section. An alignment component is formed in the at least first shaft section, and the second shaft body contacts the alignment component when the first aperture of the first shaft body is aligned with the second aperture of the second shaft body. In the embodiments described herein, the shaft assembly may be used in conjunction with a steering assembly of a vehicle, such as a car, truck, sport utility vehicle, crossover, mini-van, marine craft, aircraft, all-terrain vehicle, recreational vehicle, or other suitable vehicles, including various steering system schemes.

As noted hereinabove, traditional shaft assemblies have a number of limitations and struggle to achieve axial alignment. For example, many shaft assemblies utilize punched tabs to aid in aligning shaft sections of the assembly. While these punched tabs may provide a physical stop for alignment, the punched tabs may be formed in the shaft sections via a specific punch machine, which increases production complexity and cost. Furthermore, the process of punching the tabs through the shaft sections creates openings in the shaft assembly, which increases the risk of water intrusion and corrosion and compromises the integrity and longevity of the shaft assembly.

Other traditional shaft assemblies may utilize cold-formed flats or “bumps” formed on the shaft as locating features. However, the cold forming process is complex and expensive, making it difficult to achieve desired tolerances required for alignment of the shaft sections. For example, irregularities introduced by cold forming the shaft sections of the shaft assembly may lead to misalignment, which may impair the functionality of the assembly or necessitate additional adjustments during assembly.

The disclosed shaft assembly aims to address these shortcomings by utilizing an alignment component configured to act as a locating feature for axial alignment of shaft sections used in the shaft assembly. In these embodiments, the alignment component may form a stop that does not puncture the surface of the shaft section, thereby alleviating issues related to water intrusion and corrosion. Furthermore, the alignment component may be formed in the shaft section using an existing drilling station, such that the need for additional and/or separate equipment (e.g., punching, cold forming, etc.) is eliminated.

As will be described in additional detail herein, in some embodiments, the alignment component may further act as a travel limiting mechanism, such as a stop, configured to restrict translation of at least one shaft section of a shaft assembly. For example, in these embodiments, the alignment component may act as a stop for a section of the shaft assembly, such that the shaft section may not translate past the alignment component. In these embodiments, the alignment component may further enhance the versatility and reliability of the disclosed shaft assembly, and may ensure that the various components (e.g., shafts) of the shaft assembly remain engaged and aligned during operation.

Embodiments of shaft assemblies and methods of aligning shaft assemblies will now be described in additional detail herein. The following will now describe these shaft assemblies and methods in more detail with reference to the drawings and where like numbers refer to like structures.

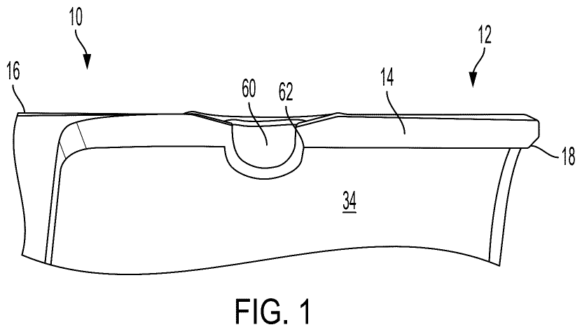

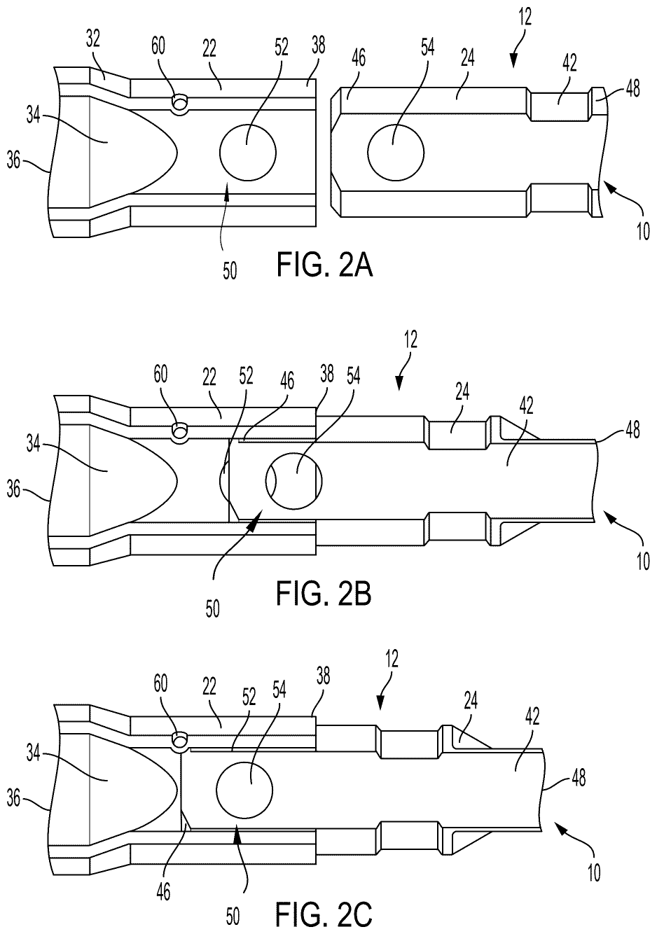

Referring now to FIG. 1-2C, a shaft assembly 10 is depicted. In these embodiments, the shaft assembly 10 may include a plurality of shaft sections 12, with each of the plurality of shaft sections 12 defining a body 14 extending between a distal end 16 and a proximal end 18. For example, as illustrated most clearly in FIG. 2A-2C, the plurality of shaft sections 12 may include a first shaft section 22 and a second shaft section 24, with at least one of the plurality of shaft sections 12 being configured to be received by at least one other of the plurality of shaft sections 12.

In these embodiments, the first shaft section 22 may define a first shaft body 32 extending between a first shaft distal end 36 and a first shaft proximal end 38, and the second shaft section 24 may define a second shaft body 42 extending between a second shaft distal end 46 and a second shaft proximal end 48. The first shaft body 32 may further define a cavity 34 configured to receive the second shaft body 42 of the second shaft section 24, such that the second shaft body 42 may axially translate within the cavity 34 of the first shaft body 32 (e.g., in a longitudinal direction along the +/−x-axis as depicted in the coordinate axes of FIGS. 2A-2C).

Although FIGS. 1 and 2A-2C depict the shaft assembly 10 as including a first shaft section 22 and a second shaft section 24, it should be appreciated that the shaft assembly 10 may include any number of the plurality of shaft sections 12 without departing from the scope of the present disclosure. For example, in some embodiments, the shaft assembly 10 may include three shaft sections, four shaft sections, or any other number of shaft sections. In embodiments in which the shaft assembly 10 includes more than a first shaft section and a second shaft section (e.g., three or more shaft sections) the plurality of shaft sections 12 may be telescopically arranged.

Referring still to FIGS. 1 and 2A-2C, each of the plurality of shaft sections 12 may further include an aperture 50, which may be aligned to secure (e.g., fasten or otherwise couple) each of the plurality of shaft sections 12 together. In these embodiments, it should be appreciated that the aperture 50 may fully extend through the body 14 of each of the plurality of shaft sections 12, such that a fastener, or other similar coupling mechanism, may be inserted through the aperture 50 formed in the body 14. For example, as depicted most clearly in FIGS. 2A-2C, the first shaft section 22 may include a first aperture 52, and the second shaft section 24 may include a second aperture 54. In these embodiments, when the first aperture 52 of the first shaft section 22 is aligned with the second aperture 54 of the second shaft section 24, a bolt, or other similar fastener, may be inserted through the first aperture 52 and the second aperture 54 to secure the first shaft section 22 to the second shaft section 24.

In order to ensure proper alignment of the first aperture 52 of the first shaft section 22 and the second aperture 54 of the second shaft section 24, at least one of the plurality of shaft sections 12 (e.g., the first shaft section 22 as depicted in FIGS. 1 and 2A-2C) may further include an alignment component 60, such as a stopper or any other similar mechanism configured to limit translation of the second shaft section 24 relative the first shaft section 22, as will be described in additional detail herein.

The alignment component 60 is most clearly depicted in FIG. 1. As illustrated in FIG. 1, the alignment component 60 may be a protrusion extending inwardly from an exterior surface of the first shaft body 32 and into the cavity 34 defined by the first shaft body 32. In these embodiments, the alignment component 60 may further include a stopper surface 62, which may engage the second shaft body 42 when the first aperture 52 of the first shaft section 22 is aligned with the second aperture 54 of the second shaft section 24. Accordingly, it should be appreciated that, in operation, contact between the stopper surface 62 of the alignment component 60 and the second shaft body 42 may indicate to a user that the first aperture 52 is aligned with the second aperture 54. It should be further understood that utilizing contact between the stopper surface 62 of the alignment component 60 and the second shaft body 42 to align the first aperture 52 and the second aperture 54 may be particularly advantageous in embodiments in which the first aperture 52 and the second aperture 54 are not visible to a user during operation.

As further depicted in FIG. 1, the alignment component 60 may be formed as a curved or semi-circular protrusion that extends at least partially into the cavity 34 defined by the first shaft body 32. However, it should be appreciated that the alignment component 60 may take any shape without departing from the scope of the disclosure. For example, although not depicted, the alignment component 60 may be square, rectangular, triangular, or any other similar shape that extends into the cavity 34 of the first shaft body 32 and is configured to aid in alignment of the first aperture 52 and the second aperture 54, as has been described herein.

Referring now to FIG. 2A - 2C, alignment of the shaft assembly 10 will be described in additional detail. For example, as depicted in FIG. 2A, the shaft assembly 10 may be situated such that the first shaft proximal end 38 of the first shaft body 32 is positioned adjacent the second shaft distal end 46 of the second shaft body 42. With the first shaft body 32 and the second shaft body 42 positioned adjacent one another, a user may insert the second shaft body 42 into the cavity 34 formed in the first shaft body 32, such that the second shaft body 42 translates axially (e.g., in the −x-direction as depicted in the coordinate axes of FIG. 2A-2C) within the first shaft body 32 towards the first shaft distal end 36. In these embodiments, as the second shaft body 42 traverse the cavity 34 of the first shaft body 32, the first aperture 52 and the second aperture 54 may begin to at least partially overlap, as is depicted in FIG. 2B.

As depicted in FIG. 2C, the second shaft body 42 may continue to translate within the cavity 34 of the first shaft body 32 (e.g., towards the first shaft distal end 36, as described herein) until the second shaft body 42 contacts the stopper surface 62 of the alignment component 60 formed in the first shaft body 32. In these embodiments, the contact between the stopper surface 62 of the alignment component 60 and the second shaft body 42 (e.g., the second shaft distal end 46) may signify to a user that the first aperture 52 is aligned with the second aperture 54. Furthermore, the stopper surface 62 of the alignment component 60 may prevent additional translation of the second shaft body 42 towards the first shaft distal end 36, such that alignment between the first aperture 52 and the second aperture 54 is maintained.

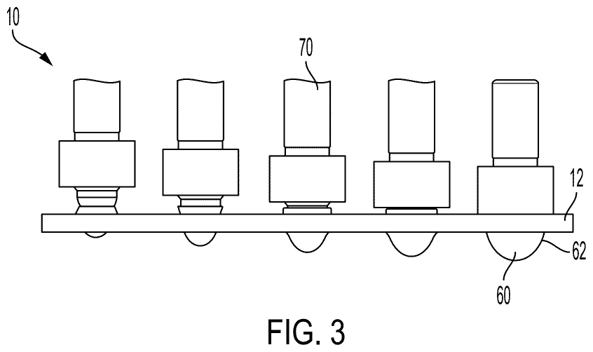

Referring now to FIG. 3, an illustrative process of forming the alignment component 60 is depicted. In these embodiments, the alignment component 60 may be formed in at least one of the plurality of shaft sections 12 (e.g., the first shaft section 22) via a flow drill process or other similar process (e.g., friction drilling, etc.) that does not puncture the body 14 of the shaft section 12. As described herein, a flow drill process may be defined as any process capable of forming a protrusion in the body 14 of the plurality of shaft sections 12 (e.g. utilizing heat from friction or other similar means) without forming a puncture in the body. For example, as illustrated in FIG. 3, a flow drill 70 may be moved into contact with the body 14 of at least one of the plurality of shaft sections 12, such that a frictional force generated by the flow drill depresses at least a portion of the body 14 inwardly (e.g., in the −y-direction as depicted in the coordinate axis of FIG. 3), such that the alignment component 60 is formed. For example, in these embodiments, the flow drill 70 may spin (e.g., rotate) as the flow drill 70 is moved into contact with the body 14, such that the rotation of the flow drill 70 and contact between the flow drill 70 and the body 14 generates the frictional force used to form the alignment component 60.

It should be appreciated that, in the embodiments described herein, the flow drill process of forming the alignment component 60 may act to alleviate issues with water intrusion, corrosion, and any other similar issues typically associated with punching operations used to form punctures and/or openings. Furthermore, it should be noted that the flow drill process described herein may be implemented into a drilling station used to manufacture the shaft assembly 10, which may act to minimize the amount of equipment needed to manufacture the shaft assembly 10.

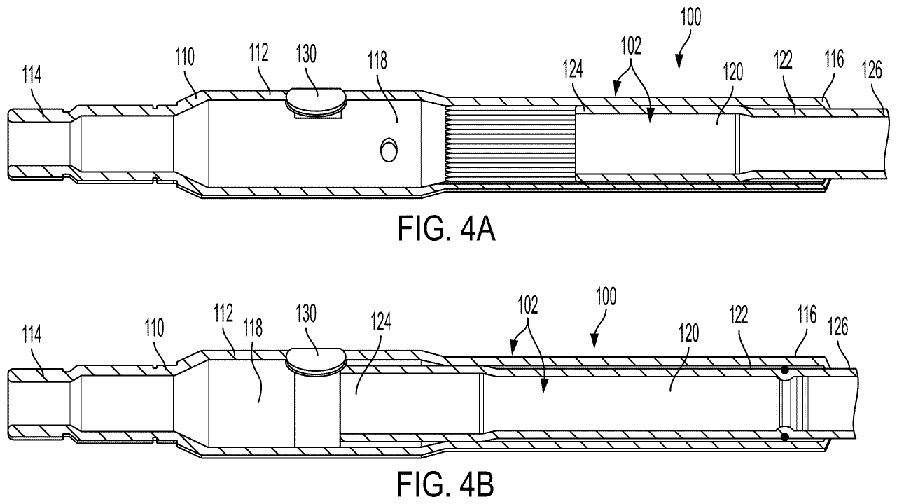

Turning now to FIGS. 4A and 4B, another embodiment of a shaft assembly 10 is depicted. In these embodiments, the shaft assembly 10 may be a steering column assembly 100 including a plurality of steering column sections 102, such as a first steering column section 110 and a second steering column section 120. The first steering column section 110 and the second steering column section 120 may be coupled together (e.g., releasably or inextricably) such that the first steering column section 110 may translate axially relative to and about the second steering column section 120.

Referring still to FIGS. 4A and 4B, in these embodiments, the first steering column section 110 may include a first column body 112 extending between a first column distal end 114 and a first column proximal end 116, with the second steering column section 120 similarly including a second column body 122 extending between a second column distal end 124 and a second column proximal end 126. In these embodiments, the first column body 112 may further define a cavity 118 which is configured to receive the second column body 122, such that the first column body 112 may translate about the second column body 122, as will be described in additional detail herein.

As further depicted in FIGS. 4A and 4B, the steering column assembly 100 may be translatable between an extended position (e.g., as depicted in FIG. 4A) and a collapsed position (e.g., as depicted in FIG. 4B). In these embodiments, translation of the first steering column section 110 relative the second steering column section 120 (e.g., in the +/−x-direction as depicted in the coordinate axes of FIGS. 4A and 4B) may move the steering column assembly 100 between the collapsed position and the extended position. Although not depicted, in the embodiments described herein, a steering mechanism, such as a steering wheel or other steering input, may be mounted to the first steering column section 110, such that translation of the steering column assembly 100 adjusts a position of the steering mechanism within a vehicle.

Referring still to FIGS. 4A and 4B, the first steering column section 110 may further include a stopper 130, or any other similar mechanism configured to limit axial translation of the first steering column section 110. In these embodiments, the stopper 130 may be formed in the first column body 112 of the first steering column section 110, such that the stopper 130 protrudes inwardly (e.g., into the cavity 118 formed within the first column body 112). It should be appreciated that the stopper 130 may be formed in the first steering column section 110 via a flow drill process or other similar process (e.g., friction drilling, etc.) that does not puncture the first column body 112 of the first steering column section.

Referring still to FIGS. 4A and 4B, operation of the steering column assembly 100 will be described in additional detail. For example, as described herein, the steering column assembly 100 may be translated between an extended position (e.g., FIG. 4A) and a collapsed position (e.g., FIG. 4B) by translating the first column body 112 of the first steering column section 110 in a first direction (e.g., in the −x-direction as depicted in the coordinate axes of FIGS. 4A and 4B) and a second direction opposite the first direction (e.g., in the +x-direction as depicted in the coordinate axes of FIGS. 4A and 4B).

More particularly, the steering column assembly 100 may be moved from the collapsed position to the extended position by translating the first column body 112 in the first direction, such that the first column proximal end 116 moves towards that the second column distal end 124. In these embodiments, as the first column body 112 translates in the first direction, a length of the steering column assembly 100 may increase such that the steering mechanism (not depicted) mounted on the first column distal end 114 moves away from a console of a vehicle in which the steering column assembly 100 is secured.

In contrast, the steering column assembly 100 may be moved from the extended position to the collapsed position by translating the first column body 112 in the second direction, such that the first column distal end 114 moves towards the second column distal end 124. In these embodiments, the first column body 112 may translate in the second direction (e.g., in the +x-direction as depicted in the coordinate axes of FIGS. 4A and 4B) until the second column distal end 124 contacts the stopper 130 formed in the first column body 112. Once the second column distal end 124 contacts the stopper 130, the stopper 130 may prevent additional translation of the first steering column section 110 in the second direction, which may prevent the steering column assembly 100 from collapsing beyond the stopper 130.

In these embodiments, it should be appreciated that the stopper 130 may be formed in a location of the first steering column section 110 that corresponds to a maximum collapsed position. For example, in some embodiments, if the first steering column section 110 translates beyond the maximum collapsed position, the first steering column section 110 may become radially misaligned and wedged about the second steering column section 120, which may prevent the steering column assembly 100 from being translated to the extended position. Accordingly, the positioning of the stopper 130 may be configured such that the maximum collapsed position corresponds to the position of the stopper 130.

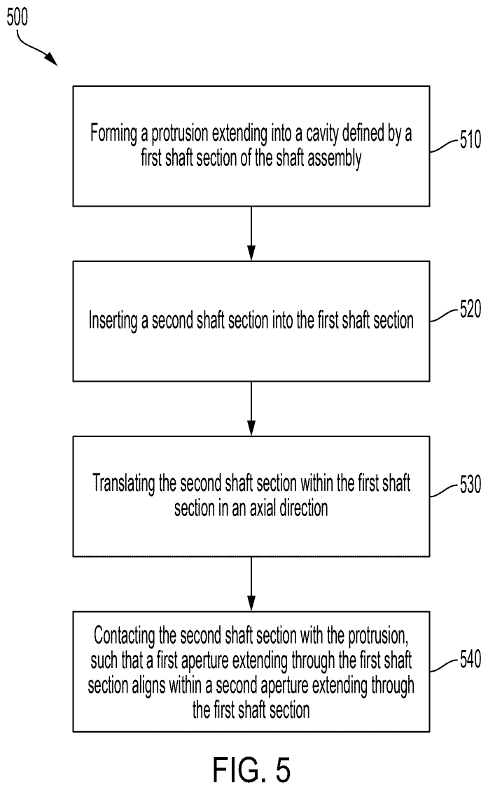

Turning now to FIG. 5, an illustrative flow diagram of a method 500 of aligning a shaft assembly is depicted. In these embodiments, the method may initially involve forming a protrusion extending into a cavity defined by a first shaft section of the shaft assembly, as depicted at block 510. With the protrusion formed in the first shaft section, the method may advance to block 520, which may involve inserting a second shaft section into the cavity of the first shaft section.

In the embodiments described herein, the second shaft section may be inserted into the first shaft section such that the second shaft section may translate within the cavity of the first shaft section. As depicted at block 530, the method may further involve translating the second shaft section within the first shaft section in the axial direction, and may further involve contacting the second shaft section with the protrusion formed in the cavity of the first shaft section, as shown at block 540. In these embodiments, a first aperture extending through the first shaft section may be placed in alignment with a second aperture extending through the second shaft section when the second shaft section contacts the protrusion.

Referring still to FIG. 5, in these embodiments, the method may further involve inserting a fastener through the first aperture of the first shaft section and the second aperture of the second shaft section to couple the first shaft section to the second shaft section. Furthermore, it should be appreciated that, in the embodiments described herein, the method step of forming the protrusion in the first shaft section may involve using a flow drill process, or any other similar friction drilling process, to create the protrusion. In these embodiments, using a flow drill or other similar friction drilling process may ensure that the protrusion is formed as a non-puncture protrusion (e.g., a protrusion that does not include a hole extending into the cavity).

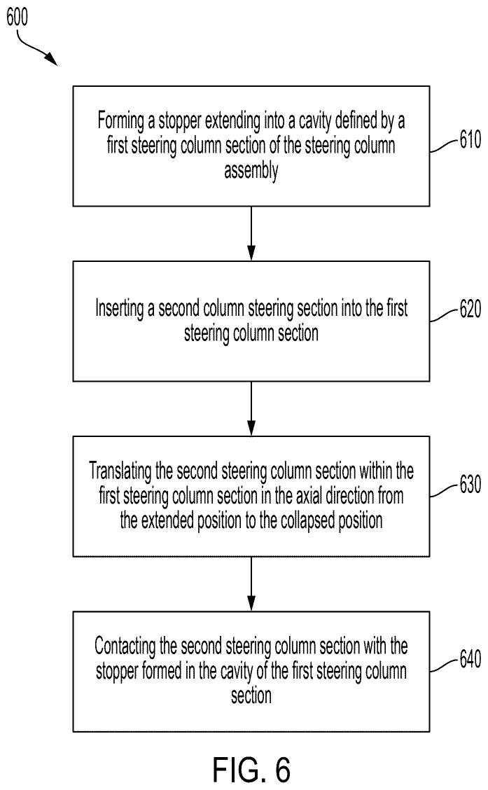

Turning now to FIG. 6, an illustrative flow diagram of a method 600 of limiting motion of a steering column assembly is depicted. In these embodiments, the method may initially involve forming a stopper extending into a cavity defined by a first column section of the steering column assembly, as depicted at block 610. With the stopper formed in the first steering column section, the method may advance to block 620, which may involve inserting a second steering column into the cavity of the first steering column section.

In the embodiments described herein, the second steering column section may be inserted into the first steering column section such that the second steering column may translate within the cavity of the first steering column section between an extended position and a collapsed position. As depicted at block 630, the method may further involve translating the second steering column section within the first steering column section in the axial direction from the extended position to the collapsed position, and may further involve contacting the second steering column section with the stopper formed in the cavity of the first steering column section, as shown at block 640. In these embodiments, contact between the second steering column section and the stopper may prevent further axial translation of the second steering column section relative the first steering column section, thereby ensuring that the second steering column section does not translate beyond a maximum collapsed position within the first steering column section.

In view of the foregoing, it should be appreciated that the embodiments described herein are related to a shaft assembly and steering column assembly. The shaft assembly includes at least a first shaft section having a first shaft body defining a cavity and a first aperture extending through the first shaft body, and at least a second shaft section having a second shaft body and a second aperture extending through the second shaft body. The second shaft section is configured to be received within the cavity of the first shaft body, such that the second shaft body axially translates within the cavity relative to the first shaft section. An alignment component is formed in the at least first shaft section, and the second shaft body contacts the alignment component when the first aperture of the first shaft body is aligned with the second aperture of the second shaft body. Because the alignment component forms a stop that does not puncture the surface of the shaft section, issues related to water intrusion and corrosion may be alleviated. Furthermore, the alignment component may be formed in the shaft section using an existing drilling station, such that the need for additional and/or separate equipment (e.g., punching, cold forming, etc.) is eliminated.

The embodiments disclosed herein may be further described with reference to the following aspects:

According to one aspect of the disclosure, and potentially in combination with other disclosed aspects of the disclosure, a shaft assembly comprises at least a first shaft section having a first shaft body defining a cavity and a first aperture extending through the first shaft body, at least a second shaft section having a second shaft body and a second aperture extending through the second shaft body, the second shaft section being configured to be received within the cavity of the first shaft body, such that the second shaft body axially translates within the cavity relative to the first shaft section; and an alignment component formed in the at least first shaft section, the alignment component being a non-puncture alignment component; wherein the second shaft body contacts the alignment component when the first aperture of the first shaft body is aligned with the second aperture of the second shaft body.

According to one aspect of the disclosure, and potentially in combination with other disclosed aspects of the disclosure, the alignment component further comprises a stopper surface that contacts the second shaft body when the first aperture is aligned with the second aperture.

According to one aspect of the disclosure, and potentially in combination with other disclosed aspects of the disclosure, the alignment component is a protrusion that extends into the cavity of the first shaft body.

According to one aspect of the disclosure, and potentially in combination with other disclosed aspects of the disclosure, the alignment component is a non-puncture alignment component that does not form an opening in the first shaft body.

According to one aspect of the disclosure, and potentially in combination with other disclosed aspects of the disclosure, the alignment component is a flow drill formed protrusion.

According to one aspect of the disclosure, and potentially in combination with other disclosed aspects of the disclosure, the alignment component prevents translation of the second shaft body beyond the alignment component in at least one direction.

According to one aspect of the disclosure, and potentially in combination with other disclosed aspects of the disclosure, a fastener extends through the first aperture and the second aperture to couple the first shaft section to the second shaft section.

According to one aspect of the disclosure, and potentially in combination with other disclosed aspects of the disclosure, the alignment component is fluidly sealed from the cavity of the first shaft body.

According to one aspect of the disclosure, and potentially in combination with other disclosed aspects of the disclosure, a steering column assembly comprises at least a first steering column section having a first column body defining a cavity; at least a second steering column section having a second column body, the second steering column section being configured to be received within the cavity of the first column body of the first steering column section; and a stopper formed in the at least first steering column section, the stopper being a non-puncture stopper that does not form an opening in the at least first steering column; wherein the steering column assembly is translatable between an extended position and a collapsed position in which the second column body contacts the stopper formed in the first column body.

According to one aspect of the disclosure, and potentially in combination with other disclosed aspects of the disclosure, the first steering column section axially translates about the second steering column section to move the steering column between the extended position and the collapsed position.

According to one aspect of the disclosure, and potentially in combination with other disclosed aspects of the disclosure, the stopper further comprises a stopper surface that contacts the second column body when the steering column assembly is in the collapsed position.

According to one aspect of the disclosure, and potentially in combination with other disclosed aspects of the disclosure, the stopper is a protrusion that extends into the cavity of the first column body.

According to one aspect of the disclosure, and potentially in combination with other disclosed aspects of the disclosure, the stopper is a flow drill formed protrusion.

According to one aspect of the disclosure, and potentially in combination with other disclosed aspects of the disclosure, the stopper prevents translation of the first column body beyond the stopper when the steering column assembly translates from to the collapsed position.

According to one aspect of the disclosure, and potentially in combination with other disclosed aspects of the disclosure, the stopper is formed in the first column body at a position corresponding to a maximum collapsed position of the steering column assembly.

According to one aspect of the disclosure, and potentially in combination with other disclosed aspects of the disclosure, a method of aligning a shaft assembly comprises forming a non-puncture protrusion extending into a cavity defined by a first shaft section of the shaft assembly; inserting a second shaft section into the first shaft section; translating the second shaft section within the first shaft section in an axial direction; and contacting the second shaft section with the non-puncture protrusion, such that a first aperture extending through the first shaft section aligns within a second aperture extending through the first shaft section.

According to one aspect of the disclosure, and potentially in combination with other disclosed aspects of the disclosure, the method further comprises inserting a fastener through the first aperture of the first shaft section and the second aperture of the second shaft section to couple the first shaft section to the second shaft section.

According to one aspect of the disclosure, and potentially in combination with other disclosed aspects of the disclosure, the non-puncture protrusion in the cavity defined by the first shaft section further comprises forming the non-puncture protrusion using a flow drill process.

According to one aspect of the disclosure, and potentially in combination with other disclosed aspects of the disclosure, the non-puncture protrusion in the cavity defined by the first shaft section further comprises forming the non-puncture protrusion using a friction drilling process.

According to one aspect of the disclosure, and potentially in combination with other disclosed aspects of the disclosure, the method step of contacting the second shaft section with the non-puncture protrusion further comprises preventing additional axial translation of the second shaft section in at least one direction.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A shaft assembly comprising:
at least a first shaft section having a first shaft body defining a cavity and a first aperture extending through the first shaft body;
at least a second shaft section having a second shaft body and a second aperture extending through the second shaft body, the second shaft section being configured to be received within the cavity of the first shaft body, such that the second shaft body axially translates within the cavity relative to the first shaft section; and
an alignment component formed in the at least first shaft section, the alignment component being a non-punctured alignment component;
wherein the second shaft body contacts the alignment component when the first aperture of the first shaft body is aligned with the second aperture of the second shaft body.

2. The shaft assembly of claim 1, wherein the alignment component further comprises a stopper surface that contacts the second shaft body when the first aperture is aligned with the second aperture.

3. The shaft assembly of claim 1, wherein the alignment component is a protrusion that extends into the cavity of the first shaft body.

4. The shaft assembly of claim 1, wherein the alignment component does not form an opening in the first shaft body.

5. The shaft assembly of claim 1, wherein the alignment component is a flow drill formed protrusion.

6. The shaft assembly of claim 1, wherein the alignment component prevents translation of the second shaft body beyond the alignment component in at least one direction.

7. The shaft assembly of claim 1, further comprising a fastener that extends through the first aperture and the second aperture to couple the first shaft section to the second shaft section.

8. The shaft assembly of claim 1, wherein the alignment component is fluidly sealed from the cavity of the first shaft body.

9. A steering column assembly comprising:
at least a first steering column section having a first column body defining a cavity;
at least a second steering column section having a second column body, the second steering column section being configured to be received within the cavity of the first column body of the first steering column section; and
a stopper formed in the at least first steering column section, the stopper being a non-punctured stopper that does not form an opening in the at least first steering column section;
wherein the steering column assembly is translatable between an extended position and a collapsed position in which the second column body contacts the stopper formed in the first column body.

10. The steering column assembly of claim 9, wherein the first steering column section axially translates about the second steering column section to move the steering column between the extended position and the collapsed position.

11. The steering column assembly of claim 9, wherein the stopper further comprises a stopper surface that contacts the second column body when the steering column assembly is in the collapsed position.

12. The steering column assembly of claim 9, wherein the stopper is a protrusion that extends into the cavity of the first column body.

13. The steering column assembly of claim 9, wherein the stopper is a flow drill formed protrusion.

14. The steering column assembly of claim 9, wherein the stopper prevents translation of the first column body beyond the stopper when the steering column assembly translates from to the collapsed position.

15. The steering column assembly of claim 9, wherein the stopper is formed in the first column body at a position corresponding to a maximum collapsed position of the steering column assembly.

16. A method of aligning a shaft assembly comprising:
forming a non-punctured protrusion extending into a cavity defined by a first shaft section of the shaft assembly;
inserting a second shaft section into the first shaft section;
translating the second shaft section within the first shaft section in an axial direction; and
contacting the second shaft section with the non-punctured protrusion, such that a first aperture extending through the first shaft section aligns within a second aperture extending through the first shaft section.

17. The method of claim 16, further comprising inserting a fastener through the first aperture of the first shaft section and the second aperture of the second shaft section to couple the first shaft section to the second shaft section.

18. The method of claim 16, wherein forming the non-punctured protrusion in the cavity defined by the first shaft section further comprises forming the non-punctured protrusion using a flow drill process.

19. The method of claim 16, wherein forming the non-punctured protrusion in the cavity defined by the first shaft section further comprises forming the non-punctured protrusion using a friction drilling process.

20. The method of claim 16, wherein the method step of contacting the second shaft section with the non-punctured protrusion further comprises preventing additional axial translation of the second shaft section in at least one direction.
